(19) United States
(12) Patent Application Publication
(10) Pub. No.: US 2006/0046943 A1
(43) Pub. Date: Mar. 2, 2006

(54) Functional systems with reduced odor cationic polygalactomannan

(76) Inventors: Paquita Erazo-Majewicz, Newark, DE (US); Jashawant M. Modi, Hockessin, DE (US)

Correspondence Address: Hercules Incorporated;Hercules Plaza, 1313 N. Market Street, Wilmington, DE, 19894-0001, US

(21) Appl. No.: 11/211,001

(22) Filed: Aug. 24, 2005

Related U.S. Application Data
(60) Provisional application No. 60/605,556, filed on Aug. 31, 2004.

(51) Int. Cl. A61Q 5/02

(52) U.S. Cl. 510/123

(57) ABSTRACT

A reduced odor composition is composed of a functional system such as household care, personal care or pet care products and at least one cationic polygalactomannan or a derivative of cationic polygalactomannan having a cationic degree of substitution (DS) lower limit of about 0.01 and an upper limit of about 3.0 and weight average molecular weight (Mw) having a lower limit of 200,000 and an upper limit of 2,000,000 a concentration with a lower limit of 0.005 wt % and an upper limit of 10 wt %, and a trimethylamine content of less than 25 ppm, wherein the composition, at an alkaline pH, has no discernible amine odor.

This application claims the benefit of U.S. Provisional Application No. 60/605,556, filed Aug. 31, 2004.

### FIELD OF INVENTION

The present invention relates to functional systems such as personal care, household, and pet care, compositions containing cationic polygalactomannan compositions, and more specifically, to functional systems containing at least one cationic polygalactotomannan or cationic derivatized polygalactotomannan wherein the functional systems have no discernible amine odor at alkaline pH values.

### BACKGROUND OF THE INVENTION

Cationic polysaccharides and other polymers have been used widely in personal care, household, industrial, and institutional products to perform a function in the final product, ranging from the use of the polymer as gellants, binders, thickeners, stabilizers, emulsifiers, spreading and deposition aids, and carriers for enhancing the rheology, efficacy, deposition, aesthetic and delivery of chemically and physiologically active ingredients in personal care,(e.g., cosmetic, oral care, baby care), household, or pet care compositions. Depending on the application, the substrate can be skin, hair, or textile substrates.

Low and high molecular weight cationic guars, such as N-Hance® or Jaguar® cationic guars, are commonly used as conditioners in personal cleansing products such as shampoos, 2-in-1 or 3-in-1 conditioning shampoos and body washes, which are formulated at acidic or neutral pH values. As a result of processing, there is often a residual level of volatile amines such as trimethylamine (TMA) present in the cationic guar composition. When cationic guars are incorporated into cleansing compositions or other personal care products, at acidic and neutral pH values, if volatile amines such as trimethylamine (TMA) are present, their characteristic “fishy” odor is not detected. This is expected, since at acidic or neutral pH values, most of the TMA is in the aqueous phase, in the nonvolatile salt form.

However, in personal care products such as personal cleansing products (hair care and body-washes), shave products, skin care products, and oral care products, and in household care products, such as detergents and fabric conditioners, formulated at alkaline pH values, an odor can develop that is characteristic of this volatile amine, if the amine content of the cationic polygalacyomannan polymer composition is above a certain level.

The cationic polygalactomannan, besides being a conditioner, is also used for rheology modification of these formulations, lather enhancement as well for lather stability and for delivery of other personal care formulation ingredients.

Cationic polysaccharides are used in hair care products to provide conditioning to the hair. In skin care products, these same polymers can provide conditioning effects to the skin. When incorporated into detergent and fabric softening formulations, these same polymers can provide conditioning, softening, and antistatic characteristics to fabrics.

Wet and dry combability measurements are typical test methods used to measure conditioning performance in shampoo and conditioner applications. Commercial cationic conditioning polymers in the marketplace have been reported to reduce the wet combing force experienced on combing wet hair by 30%-80% relative to the shampoo containing no polymer.

However, as a result of processing, including molecular weight reduction processing, at alkaline pH values, an amine odor is apparent in some formulated products that contain cationic galactomannan polymers such as cationic guars. For example, in personal cleansing products and in household products, such as body wash formulas, shampoo formulas, detergents and fabric conditioners, formulated at alkaline pH values, an odor develops that is characteristic of amines if the amine content of the cationic guar is above a certain threshold level. The amine odor can also be detected when cationic guar is exposed to above neutral ph conditions during the manufacturing of personal care, household or pet care products

A need still exists in the marketplace, for personal care, household care, and pet care compositions containing cationic polygalactomannans wherein the composition has no discernible amine odor at alkaline pH values.

### SUMMARY OF THE INVENTION

This invention is directed to a functional system selected from personal care product, household product, or pet care product and at least one cationic polygalactotomannan-or cationic derivatized polygalactotomannan-having a lower limit concentration of 0.005 wt % and an upper limit concentration of 10 wt %, the cationic polygalactomannan or derivative thereof having a weight average molecular weight (Mw) with a lower limit of 200,000 and an upper limit of 2,000,000, and optionally at least one other active personal care, household care, or pet care ingredient, wherein the functional system has no discernible amine odor at alkaline pH values, quantified as a trimethylamine content in the cationic polygalactomannan being below 25 ppm.

### DETAILED DESCRIPTION OF THE INVENTON

It has been found that incorporation of cationic polygalactotomannan having trimethylamine contents of less than 25 ppm, preferably less than 20 ppm, and more preferably less than 15 ppm, into personal care, household care, or pet care formulations at cationic polymer concentrations having an upper limit of 10 wt %, preferably 5 wt %, and with lower limit preferably 1.0%, and even more preferably 0.5 wt % leads to low odor formulations at alkaline pH values.

In accordance with the present invention, the cationic, polygalactomannan or derivative thereof generally has a cationic degree of substitution (DS) lower limit of about 0.01 and an upper limit of about 3.0. Preferably, the lower limit of the cationic DS is 0.05, and more preferably 0.1 and even more preferably 0.2. Preferably, the upper limit of the cationic DS is 2.0, more preferably 1.0. The cationic polygalactomannan or derivative thereof of the present invention generally has a weight average molecular weight (Mw) with a lower limit of about 200,000 and an upper limit of about 2,000,000 preferably, the lower limit of the molecular weight is 350,000, and more preferably 500,000. Preferably, the upper limit of the molecular weight is 1,500,000, more preferably 1,000,000.

In accordance with present invention, the at least one cationic polygalactotomannan or cationic derivatized polygalactotomannan has a boron content of less than 1000 ppm per gram of polygalactomannan, with preferably less than 500 and more preferably less than 50 ppm.

The polygalactomannan gum from which the cationic polymers of the present invention are derived are guar, locust bean, honey locus, and flame tree.

The cationic functionality of the polygalactomannan or derivatized polygalactomannan can be added to the backbone by known methods. For example, the polygalactomannan material can be reacted for a sufficient time and at a sufficient temperature with tertiary amino or quaternary ammonium alkylating reagents, such 2-dialkylaminoethyl chloride and quaternary ammonium compounds such as 3-chloro-2-hydroxypropyltrimethylammonium chloride, and 2,3-epoxy-propyltrimethylammonium chloride. Preferred examples include glycidyltrialkylammonium salts and 3-halo-2-hydroxypropyltrialkylammonium salts such as glycidyltrimethylammonium chloride, glycidyltriethylammonium chloride, gylcidyltripropylammonium chloride, glycidylethyldimethylammonium chloride, glycidyidiethylmethylammonium chloride, and their corresponding bromides and iodides; 3-chloro-2-hydroxypropyltrimethylammonium chloride, 3-chloro-2-hydroxypropyltriethylammonium chloride, 3-chloro-2-hydroxypropyltripropylammonium chloride, 3-chloro-2-hydroxypropylethyldimethylammonium chloride, and their corresponding bromides and iodides; and quaternary ammonium compounds such as halides of imidazoline ring containing compounds.

The cationic polygalactomannan may also contain other substituent groups such as nonionic substituents, i.e., hydroxyalkyl wherein the alkyl represents a straight or branched hydrocarbon moiety having 1 to 30 carbon atoms (e.g., hydroxyethyl, hydroxypropyl, hydroxybutyl) or anionic substituents, such as carboxymethyl groups are optional. These optional substituents are linked to the polygalactotomannan by the reaction with reagents such as (1) alkylene oxides (e.g., ethylene oxide, propylene oxide, butylene oxide) to obtain hydroxyethyl groups, hydroxypropyl groups, or hydroxybutyl groups, or with (2) chloromethyl acetic acid to obtain a carboxymethyl group. The process for preparing derivatized polygalactomannan is well known in the art. The cationic polygalactomannan may also contain mixture of one or more other substituent groups such as nonionic, anionic and cationic substituents

These polymers may be useful as film-formers, deposition agents, and co-deposition agents onto hair, skin, and textiles, aiding in protection of the hair, skin, and textile substrates from moisture-loss, protection of these substrates from mechanical stresses, aiding deposition of sunscreens and subsequent protection of these substrates from UV radiation, enhancing deposition of fragrance or flavor onto substrates and entrapping fragrance and flavor leading to their improved longevity on these substrates, or aiding deposition of antimicrobial reagents and other active personal care ingredients, resulting in improved longevity of the active on the substrate. In addition, these polymers find use in oral care applications such as dentifrices and denture adhesives to deliver prolonged flavor retention and flavor release and delivery of actives such as drugs. Prolonged release of antimicrobial and biocide agents from these polymers may also find usefulness in household and personal care applications, such as skin and hair treatment formulas and in oral care applications such as dentifrice, denture adhesives, and whitening strips.

In accordance with the present invention, the functional system is an oil-in-water or water-in-oil emulsion or an aqueous solution or dispersion or suspension. The functional system can preferably contain water in an amount of 50-99% by weight of the total composition.

In accordance with this invention, the personal care, (e.g., baby care, oral care, skin care, sun care, hair care nail care and cosmetics) compositions and household care compositions including pet care compositions containing cationic galactomannan polymers having a weight average molecular weight (Mw) with a lower limit of about 200,000 and an upper limit of about 2,000,000, and a trimethylamine content less than 25 ppm demonstrate good conditioning performance with no discernible amine odor at acidic, neutral, or alkaline pH values in personal care compositions (i.e., haircare, skincare, and oral care compositions and in household care compostions including pet care compostions). In the products of this invention, the sustrates may be skin, hair or textile.

The personal care compositions of the invention contain a cationic polygalactomannan and a personal care ingredient. The personal care ingredient includes, but is not limited to, active ingredients, such as for example analgesics, anesthetics, antibiotic agents, antifungal agents, antiseptic agents, antidandruff agents, antibacterial agents, vitamins, hormones, antidiarrhea agents, corticosteroids, anti-inflammatory agents, vasodilators, kerolytic agents, dry-eye compositions, wound-healing agents, anti-infection agents, emollients, emulsifiers, suspending agent, styling-aid, hair and skin coloring agents, tanning agents, UV absorbers and UV blockers, lubricating agents, moisture barrier agents, moisture/water repellent agents, healing aids, adhesives, salts as well as solvents, diluents, adjuvants and other ingredients such as water, ethyl alcohol, isopropyl alcohol, propylene glycol, higher alcohols, glycerine, sorbitol, mineral oil, preservatives, surfactants, propellants, fragrances, essential oils, and viscosifying agents.

In accordance with the present invention, the personal care or cosmetic ingredient must provide some benefit to the user's body. Personal care compositions include hair care, skincare, sun care, baby care, nail care, cosmetics and oral care compositions. Examples of substances that may suitably be included, but not limited to, in the personal care active ingredients according to the present invention are as follows:

1) Perfumes, which give rise to an olfactory response in the form of a fragrance and deodorant perfumes which in addition to providing a fragrance response can also reduce body malodor;

2) Skin coolants, such as menthol, menthyl acetate, menthyl pyrrolidone carboxylate N-ethyl-p-menthane-3-carboxamide and other derivatives of menthol, which give rise to a tactile response in the form of a cooling sensation on the skin;

3) Emollients, such as isopropylmyristate, silicone materials, mineral oils and vegetable oils which give rise to a tactile response in the form of an increase in skin lubricity and moisture barrier;

4) Deodorants other than perfumes, whose function is to reduce the level of or eliminate micro flora at the skin surface, especially those responsible for the development of body malodor. Precursors of deodorants other than perfume can also be used;

5) Antiperspirant actives, whose function is to reduce or eliminate the appearance of perspiration at the skin surface;

6) Moisturizing agents, that keep the skin moist by either adding moisture or preventing from evaporating from the skin;

7) Cleansing agents, that remove undesirable naturally occurring or foreign materials, dirt and oil from the skin;

8) Sunscreen active ingredients that protect the skin and hair from UV and other harmful light rays from the sun. In accordance with this invention a therapeutically effective amount will normally be from 0.01 to 10% by weight, preferable 0.1 to 5% by weight of the composition;

9) Hair treatment agents, that condition the hair, cleanse the hair, detangles hair, acts as styling agent, volumizing and gloss agents, color retention agent, anti-dandruff agent, hair growth promoters, hair dyes and pigments, hair perfumes, hair relaxer, hair bleaching agent, hair moisturizer, hair oil treatment agent, and antifrizzing agent;

10) Oral care agents, such as dentifrices and mouth washes, that clean, whiten, delivers actives, deodorize and protect the teeth and gum;

11) Denture adhesives that provide adhesion properties to dentures and delivers actives;

12) Shaving products, such as creams, gels and lotions and razor blade lubricating strips;

13) Tissue paper products, such as moisturizing or cleansing tissues;

14) Beauty aids, such as foundation powders, lipsticks, and eye care; and

15) Textile products, such as moisturizing or cleansing wipes.

In accordance with the present invention, the household care compositions of the invention include a cationic polygalactomannan and a household care active ingredient. The household care active ingredient must provide some benefit to the user. Examples of substances that may suitably be included, but not limited to, according to the present invention are as follows:

1 ) Perfumes, which give rise to an olfactory response in the form of a fragrance and deodorant perfumes which in addition to providing a fragrance response can also reduce odor;

2) Insect repellent agent whose function is to keep insects from a particular area or attacking skin;

3) Bubble generating agent, such as surfactant that generates foam or lather;

4) Pet deodorizer or insecticides such as pyrethrins that reduces pet odor;

5) Pet cleansing shampoo agents and actives, whose function is to remove dirt, undesirable naturally occurring material, foreign material and germs from the skin and hair surfaces;

6) Industrial grade bar, shower gel, and liquid soap actives that remove germs, dirt, grease and oil from skin, sanitizes skin, and conditions the skin;

7) All purpose cleaning agents, that remove dirt, oil, and grease, germs from the surface in areas such as kitchens, bathroom, and public facilities;

8) Disinfecting ingredients that kill or prevent growth of germs in a house or public facility;

9) Rug and Upholstery cleaning actives which lift and remove dirt and foreign particles from the surfaces and also deliver softening and perfumes;

10) A laundry softener active, which reduces static and makes fabric feel softer;

11) Laundry detergent ingredients which remove dirt, oil, grease, stain, odor and kills germs;

12) Laundry or detergent or fabric softener ingredients that reduce color loss during the wash, rinse, and drying cycle of fabric care;

13) Dishwashing detergents which remove stains, food, germs;

14) Toilet bowl cleaning agents, which remove stains, kills germs, and deodorizes;

15) Laundry prespotter actives which helps in removing stains from clothes;

16) Fabric sizing agent which enhances appearance of the fabric;

17) Vehicle cleaning actives which removes dirt, grease, etc. from vehicles and equipment;

18) Textile products, such as dusting or disinfecting wipes,

The above list of personal care and household active ingredients are only examples and are not a complete list of active ingredients that can be used. Other ingredients that are used in these types of products are well known in the industry. In addition to the above ingredients conventionally used, the composition according to the present invention can optionally also include, but is not limited to, ingredients such as a colorant, preservative, antioxidant, nutritional supplements, alpha or beta hydroxy acid, activity enhancer, emulsifiers, functional polymers, viscosifying agents (such as salts, i.e., NaCl, NH4C, KCl, Na₂SO₄, water-soluble polymers, i.e., hydroxyethyl cellulose, hydroxypropylmethyl cellulose, and fatty alcohols, i.e., cetyl alcohol), alcohols having 1-6 carbons, fats or fatty compounds, antimicrobial compound, zinc pyrithione, silicone material, hydrocarbon polymer, emollients, oils, surfactants, medicaments, flavors, fragrances, suspending agents, and mixtures thereof.

In accordance with the present invention, examples of functional polymers that can be used in blends with the cationic polygalactomannans in the personal care and household compositions of the invention include hydrophobically modified polysaccharides or derivatives thereof, water-soluble polymers such as acrylic acid homopolymers such as Carbopol® product and anionic and amphoteric acrylic acid copolymers, vinylpyrrolidone homopolymers and cationic vinylpyrrolidone copolymers; nonionic, cationic, anionic, and amphoteric cellulosic polymers such as hydroxyethylcellulose, hydroxypropylcellulose, carboxymethylcellulose, hydroxypropylmethylcellulose, cationic hydroxyethylcellulose, cationic carboxymethylhydroxyethylcellulose, and cationic hydroxypropylcellulose; acrylamide homopolymers and cationic, amphoteric, and hydrophobic acrylamide copolymers, polyethylene glycol polymers and copolymers, hydrophobic polyethers, hydrophobic polyetheracetals, hydrophobically-modified polyetherurethanes and other polymers referred to as associative polymers, hydrophobic cellulosic polymers, polyethyleneoxide-propylene oxide copolymers, and nonionic, anionic, hydrophobic, amphoteric, and cationic polysaccharides such as xanthan, chitosan, carboxymethyl guar, alginates, gum arabic, hydroxypropyl guar, carboxymethyl guar hydroxypropyltrimethylammonium chloride, guar hydroxypropyltrimethylammonium chloride, and hydroxypropyl guar hydroxypropyltrimethylammonium chloride.

In accordance with the invention, the silicone materials which can be used are polyorganosiloxanes that can be in the form of polymers, oligomers, oils, waxes, resins, or gums or polyorganosiloxane polyether copolyols, amodimethicones, cationic polydimethylsiloxane materials and any other silicone material that is used in personal care or household compositions.

For a more detailed understanding of the invention, reference can be made to the following examples which are intended as further illustration of the invention, and are not to be construed in a limiting sense.

### EXAMPLES 1-18

Shampoo formulations containing cationic guar polymers having varying TMA contents were formulated at acidic (Table 1) and at alkaline (Table 2) pH values according to Procedure 1.

The TMA content of cationic guar polymers was determined using a Headspace SPME/GC/FID method. This method was used to determine trimethylamine (TMA) in cationic guar polymer solutions. The sample was adjusted to pH 8.5 with buffer in a headspace vial and TMA was extracted with a solid phase microextraction (SPME) fiber. TMA was desorbed from the fiber in a gas chromatography (GC) inlet and quantified using flame ionization detection (FID). Calibration was determined with external standards. The results are reported as ug/g (ppm) to two significant figures.

The odor in shampoo and bodywash samples was assessed by a panel. Odor panelists were asked to open each sample and assess the headspace for odor for 15 seconds. As shown by the results in Table 1, as expected, in shampoos formulated at a pH of 5.5-6.0, none of the panel members detected amine, fishy, or offensive odor, even in the shampoo formulated with polymers containing the highest levels of TMA in Examples 7,8, and 9.

In Table 2, in shampoos formulated at a pH of 8.0-8.5, nearly all panel members detected amine, fishy, or offensive odor in shampoos formulated with the cationic guar polymers containing the highest levels of TMA in Examples 16, 17, and 18. Only one panel member noted an odor in the shampoo Example of the invention, containing the cationic guar having a TMA content of 23 ppm TMA, Example 15. No odor was detected in other shampoos of the invention at alkaline pH values, Examples 11-14, formulated with cationic guars containing less than 23 ppm TMA.

The results in Tables 1 and 2 demonstrate that the TMA odor was most detectable in personal care products such as shampoos at alkaline pH values when the TMA content of the cationic polygalactomannan was greater than 23 ppm. The Examples of the invention, Examples 2-6 and Examples 11-15, were formulated with cationic polygalactomannans containing less than 25 ppm TMA, and no significant odor was detected in these formulations at alkaline pH values.

Procedure I: Clear Conditioning Shampoo with Natrosol® 250HHR hydroxyethylcellulose and Cationic Guar

Shampoo formulations were prepared, containing cationic polygalactotomannans in Table 1 or a control shampoo in which water was substituted for the cationic guar solution. The aqueous solutions of cationic guar were adjusted for their total solids content and the water charge was adjusted accordingly. Two samples of each formulation were made, one sample adjusted to pH 5.5-6.0 and one sample adjusted to pH 8.0-8.5.

A large batch of the shampoo formulation was prepared in which 10% of the water charge was held out in order to allow for the addition of the various cationic guar polymer solutions. Two-percent solutions of each of the cationic guar polymers to be tested were prepared, and shampoos containing 0.20% active cationic guar were prepared by adding 10 ppw of the 2.0% polymer solution to 90 ppw of the shampoo stock solution. The dry ingredient charges were adjusted for their moisture content and the water charge was adjusted accordingly.

Shampoo Stock Solution:

Part A

| | |
|---|---|
| Deionized water | 56.50 |
| Hydroxyethylcellulose (HEC) | 0.50 |
| 1.0% NaOH solution | q.s. |

Part B

| | |
|---|---|
| Sodium lauryl sulfate (SLS) | 17.00 |
| Sodium laureth sulfate (SLES) | 13.00 |
| Cocamindopropylbetaine (CAPB) | 2.50 |
| DMDM hydantoin | 0.50 |
| | 90.00 |

Part A—Charged Deionized water to the mixing vessel, added HEC while mixing, mixed 10 minutes to disperse. Adjusted the pH of mixture to 8.0-8.5 with 1.0% NaOH solution. Mixed 30 minutes, then re-adjusted the pH to 8.0-8.5, continued mixing additional 30 minutes.

Part B—Added in order to Part A while mixing: SLS, SLES, CAPB, and DMDM hydantoin. Mixed 30 minutes.

Polymer Solutions:

| | |
|---|---|
| Deionized water | 97.50 |
| Cationic guar polymer | 2.00 |
| 5.0% Citric acid solution | q.s. |
| DMDM hydantoin | 0.50 |
| | 100.00 |

Charged Deionized water to the mixing vessel, added cationic guar polymer while mixing, mixed 10 minutes to disperse. Adjusted the pH of mixture to 6.0-6.5 with 5.0% citric acid solution. Mixed 30 minutes, then re-adjusted the pH to 6.0-6.5, added DMDM hydantoin, continued mixing additional 30 minutes.

Shampoos at pH 5.5-6.0: Examples 1-9

| | |
|---|---|
| Stock solution | 90.00 |
| 2.0% Cationic guar solution | 10.00 |
| 5.0% Citric acid solution | q.s. |
| | 100.00 |

Samples of 100-gram shampoos were prepared from the stock solution: One sample contained 0.20% N-Hance 3269 product, one contained 0.20% N-Hance 3270 product, one sample contained 0.20% N-Hance 3196 product, and a control shampoo with no polymer, in which deionized water was substituted for the cationic guar solution. The cationic guar solutions were added while mixing to the shampoo stock solution and mixed 15 minutes. Each of these samples was adjusted to pH 5.5-6.0 with 5.0% citric acid and mixed another 15 minutes.

Clear Conditioning Shampoo at pH 8.0-8.5 with Natrosol ®
250HHR and 0.20% active Cationic Guar:

| Shampoo Stock Solution at pH 8.0-8.5 | |
|---|---|
| Shampoo Stock Solution: | 100.00 |
| 1.0% NaOH solution to pH 8.0-8.5 | q.s. |
| | 100.00 |

Cationic Guar Polymer Solutions:

| | |
|---|---|
| Deionized water | 97.50 |
| Cationic guar polymer | 2.00 |
| 5.0% Citric acid solution | q.s. |
| DMDM hydantoin | 0.50 |
| | 100.00 |

Charged Deionized water to the mixing vessel, added conditioning polymer while mixing, mixed 10 minutes to disperse. Adjusted the pH of mixture to 6.0-6.5 with 5.0% citric acid solution. Mixed 30 minutes, then re-adjusted the pH to 6.0-6.5, added DMDM hydantoin, continued mixing additional 30 minutes.

Shampoos at pH 8.0-8.5: Examples 10-18

| | |
|---|---|
| Shampoo Stock solution pH 8-8.5 | 90.00 |
| 2.0% Cationic guar solution | 10.00 |
| 1.0% NaOH solution to pH 8.0-8.5 | q.s. |
| | 100.00 |

Samples of 100-grams of each shampoo containing 0.20% cationic guar solution were prepared from the stock solution. A control shampoo with no polymer was also prepared, in which deionized water was substituted for the cationic guar solution. The cationic guar solutions were added while mixing to the shampoo stock solution and mixed 15 minutes. Each of these samples was adjusted to pH 8.0-8.5 with 1.0% NaOH and mixed an additional 15 minutes.

In this Shampoo experiment, at pH 8.0-8.5, one of the three panel members detected amine odor at TMA levels of 12.4 and 23.3 ppm. Two of the panel members detected no amine, fishy, or offensive odors at these levels.

| | | | % |
|---|---|---|---|
| Materials | Trademark | Supplier | Active |
| Hydroxyethyl- | Natrosol ® | Hercules Inc. | 96.45% |
| cellulose | 250HHR-CS | | |
| Sodium lauryl | Stepanol ® WAC | Stepan Co. | 29% |
| sulfate | | | |
| Sodium laureth | Rhodapex ® ES-STD | Rhodia | 27% |
| sulfate | | | (3-EO) |
| Cocamidopropyl- | Amphosol ® CA | Stepan Co. | 30% |
| betaine | | | |
| DMDM | Glydant ® | Lonza Group | 100% |
| Hydantoin | | | |
| Cationic | N-Hance ® 3269 | Hercules Inc. | 90.96% |
| guar | | | |
| Cationic | Jaguar ® C-13-S | Rhodia | 90.36% |
| guar | | | |
| Cationic | Jaguar ® C-162 | Rhodia | 91.08% |
| hydroxypropyl | | | |
| Guar | | | |

TABLE 1
SHAMPOO Formulations containing Cationic Polygalactotomannans at pH 5.5-6.0

| Example | Polymer | DS⁴ | Mw⁵ | Concentration | TMA⁶ | Panael 1 | Panel 2 | Panael 3 | Panael 4 |
|---|---|---|---|---|---|---|---|---|---|
| Control - | Control - | — | — | 0 | 0 | None | None | Trace | Slight |
| 1 | water | | | | | | | Surfactant | Surfacant |
| 2 | Jaguar ® | 0.12 | 1,116,000 | 0.2% | 4.3 | Slight | None | None | Trace |
| | C13S¹ | | | | | (preservative) | | | Surfactant |
| 3 | Jaguar ® | 0.14 | 1,115,000 | 0.2% | 0.9 | None | None | None | Trace |
| | C162² | | | | | | | | Surfactant |
| 4 | N-Hance ® | 0.12 | 1,200,000 | 0.2% | 6.7 | None | None | Slight | Not tested |
| | 3196³ | | | | | | | (surfactant) | |
| 5 | N-Hance ® | 0.11 | 546,000 | 0.2% | 12.4 | None | None | None | Moderate |
| | 3270³ | | | | | | | | Soapy |
| 6 | N-Hance ® | 0.11 | 453,000 | 0.2% | 23.3 | None | None | None | Not tested |
| | 3269³ | | | | | | | | |
| 7 | N-Hance ® | | 447,000 | 0.2% | 140 | None | None | None | Trace |
| | 3269³ | | | | | | | | Surfactant |
| 8 | N-Hance ® | 0.11 | 508,000 | 0.2% | 275 | None | None | None | Trace |
| | 3269³ | | | | | | | | Surfactant |
| 9 | N-Hance ® | 0.13 | 510,000 | 0.2% | 500 | None | None | None | Moderate |
| | 3269³ | | | | | | | | Surfactant |

¹Guar hydroxypropyl trimonium chloride sold under the trademark Jaguar ® by Rhodia
²Hydroxypropyl guar hydroxypropyltrimonium chloride sold under the trademark Jaguar ® by Rhodia
³Guar hydroxypropyl trimonium chloride sold under the trademark N-Hance ® by Hercules Incorporated.
⁴The Degree of substitution was determined by measurement of the moles of quaternary ammonium groups bound to the polymer backbone using standard NMR techniques of integration.
⁵The weight average molecular weight, Mw, was determined using size exclusion chromatography.
⁶See text

TABLE 2
SHAMPOO Formulations containing Cationic Polygalactotomannans at pH 8.0-8.5

| Example | Polymer | DS⁴ | Mw⁵ | Concentration | TMA⁶ | Panel 1 | Panel 2 | Panel 3 | Panel 4 |
|---|---|---|---|---|---|---|---|---|---|
| Control - | Control - water | — | — | 0 | 0 | None | Trace | None | Trace |
| 10 | | | | | | | amine | | Soapy |
| 11 | Jaguar ® | 0.12 | 1,116,000 | 0.2% | 4.3 | Slight | None | None | Trace |
| | C13S¹ | | | | | (preservative) | | | Soapy |
| 12 | Jaguar ® | 0.14 | 1,115,000 | 0.2% | 0.9 | None | None | None | Trace |
| | C162² | | | | | | | | Soapy |
| 13 | N-Hance ® | 0.12 | 1,200,000 | 0.2% | 6.7 | None | None | Slight | Not |
| | 3196³ | | | | | | | (surfac- | Tested |
| | | | | | | | | tant) | |
| 14 | N-Hance ® | 0.11 | 546,000 | 0.2% | 12.4 | Very slight | None | None | Moderate |
| | 3270³ | | | | | (unknown) | | | Soapy |
| 15 | N-Hance ® | 0.11 | 453,000 | 0.2% | 23.3 | None | None | Slight | Not |
| | 3269³ | | | | | | | amine | Tested |
| 16 | N-Hance ® | | 447,000 | 0.2% | 140 | Slight | Trace | None | Trace |
| | 3269³ | | | | | Fishy | Amine | | Soapy |
| 17 | N-Hance ® | 0.11 | 508,000 | 0.2% | 275 | Very slight | None | Trace | Trace |
| | 3269³ | | | | | Fishy | | Fishy | Soapy |
| 18 | N-Hance ® | 0.13 | 510,000 | 0.2% | 500 | Very slight | Trace | Trace | Moderate |
| | 3269³ | | | | | Fishy | Amine | Bread | Soapy |

¹Guar hydroxypropyl trimonium chloride sold under the trademark Jaguar ® by Rhodia.
²Hydroxypropyl guar hydroxypropyltrimonium chloride sold under the trademark Jaguar ® by Rhodia.
³Guar hydroxypropyl trimonium chloride sold under the trademark N-Hance ® by Hercules Incorporated.
⁴The degree of substituition was determined by measurement of the moles of quaternary ammonium groups bound to the polymer backbone using standard NMR techniques of integration.
⁵The weight average molecular weight, Mw, was determined using size exclusion chromatography.
⁶See text.

### EXAMPLES 19-38

Bodywash formulations containing cationic guar polymers having varying A contents were formulated at acidic (Table 3) and at alkaline (Table 4) pH values according to Procedure II.

Odor panelists were asked to open each sample and assess the headspace for odor for 15 seconds. As shown by the results in Table 3, in bodywashes formulated at a pH of 5.5-6.0, a trace amine odor was detected in the bodywash base control sample(Example 19). This odor perception persisted for one panel member through Examples 20-28 of the invention, and it is attributed to the bodywash base background at acidic pH values. No fragrance was added to these formulations to mask the background odor.

In Table 4, for bodywashes formulated at a pH of 8.0-8.5, no fishy amine odor was detected in Examples 31-34, although a slight oxidized odor was noted by the same panel member in the control without the cationic guar. A trace fishy amine odor was detected in the example of the invention Example 35 at alkaline pH values. A majority of panel members detected amine, fishy, or offensive odor in Examples 36-38, bodywashes formulated with cationic guar polymers containing the levels of TMA greater than 100 ppm.

The results in Tables 3 and 4 demonstrate that the TMA odor was most detectable in personal care products such as bodywashes at alkaline pH values when the TMA content of the cationic polygalactomannan was greater than 12 ppm. This conclusion was supported by the low odor performance of Examples 32-35. These Examples of the invention were formulated with cationic polygalactomannans containing less than 25 ppm TMA, and no significant odor was detected in these formulations at alkaline pH values. This same reduced odor performance was also seen in shampoo formulations. This same reduce odor performance is expected in cosmetic products, baby care products, household products, and pet care products that are formulated with cationic polygalactomannans containing less than 25 ppm TMA at alkaline pH values.

Procedure II

Body Wash at pH 5.5-6.0 with Natrosol 250HHR and 0.40% Cationic Guar:

A large batch of the Body Wash formulation was prepared in which 20% of the water charge was held out in order to allow for the addition of the various conditioning polymer solutions. The stock solution was divided into two samples: one sample was adjusted to pH 5.5-6.0, and one sample was adjusted to pH 8.0-8.5. Two-percent solutions of each of the cationic guar polymers to be tested were prepared, and Body Washes containing 0.40% active cationic guar polymer were prepared by adding 20 parts per weight (ppw) of the 2.0% polymer solution to 80 ppw of the Body Wash stock solution. The dry ingredient charges were adjusted for their moisture content and the water charge was adjusted accordingly.

Body Wash Stock Solution:

Part A

| | |
|---|---|
| Deionized water | 43.50 |
| Hydroxyethylcellulose (HEC) | 0.50 |
| 1.0% NaOH solution | q.s. |

Part B

| | |
|---|---|
| Sodium laureth sulfate (SLES) | 42.00 |
| Cocamindopropylbetaine (CAPB) | 3.00 |
| Methyl gluceth-20 | 0.50 |
| DMDM hydantoin | 0.50 |
| | 90.00 |

Part A—Charged Deionized water to the mixing vessel, added HEC while mixing, mixed 10 minutes to disperse. Adjusted the pH of mixture to 8.0-8.5 with 1.0% NaOH solution. Mixed 30 minutes, then re-adjusted the pH to 8.0-8.5, continued mixing additional 30 minutes.

Part B—Added in order to Part A while mixing: SLES, CAPB, Methyl gluceth-20, and DMDM hydantoin. Mixed 30 minutes.

Body Wash Stock Solution at pH 5.5-6.0

| | |
|---|---|
| Body Wash Stock Solution: | 100.00 |
| 5.0% Citric acid solution to pH 5.5-6.0 | q.s. |
| | 100.00 |

Polymer Solutions:

| | |
|---|---|
| Deionized water | 97.50 |
| Cationic guar polymer | 2.00 |
| 5.0% Citric acid solution | q.s. |
| DMDM hydantoin | 0.50 |
| | 100.00 |

Charged Deionized water to the mixing vessel, added conditioning polymer while mixing, mixed 10 minutes to disperse. Adjusted the pH of mixture to 6.0-6.5 with 5.0% Citric acid solution. Mixed 30 minutes, then re-adjusted the pH to 6.0-6.5, added DMDM hydantoin, continued mixing additional 30 minutes.

Body Wash at pH 5.5-6.0: Examples 19-29

| | |
|---|---|
| Stock solution | 80.00 |
| 2.0% Cationic guar solution | 20.00 |
| 5.0% Citric acid solution | q.s. |
| 1.0% NaOH solution | q.s. |
| | 100.00 |

Samples of 1 00-gram body washes containing 0.40% cationic guar solution were prepared from the stock solution. A control body wash with no polymer was also prepared, in which deionized water was substituted for the cationic guar solution. The cationic guar solutions were added while mixing to the body wash stock solution and mixed 15 minutes. Each of these samples was adjusted to pH 5.5-6.0 with 5.0% citric acid solution and mixed an additional 15 minutes.

Body Wash at pH 8.0-8.5 with Natrosol
250HHR and 0.40% Cationic Guar:

| | |
|---|---|
| Body Wash Stock Solution: | 100.00 |
| 1.0% NaOH solution to pH 8.0-8.5 | q.s. |
| | 100.00 |

Polymer Solutions:

| | |
|---|---|
| Deionized water | 97.50 |
| Cationic guar polymer | 2.00 |
| 5.0% Citric acid solution | q.s. |
| DMDM hydantoin | 0.50 |
| | 100.00 |

Charged Deionized water to the mixing vessel, added conditioning polymer while mixing, mixed 10 minutes to disperse. Adjusted the pH of mixture to 6.0-6.5 with 5.0% citric acid solution. Mixed 30 minutes, then re-adjusted the pH to 6.0-6.5, added DMDM hydantoin, continued mixing additional 30 minutes.

Body Wash at pH 8.0-8.5: Examples 30-38

| | |
|---|---|
| Stock solution | 80.00 |
| 2.0% Cationic guar solution | 20.00 |
| 1.0% NaOH solution to pH 8.0-8.5 | q.s. |
| | 100.00 |

Samples of 1 00-gram body washes containing 0.40% cationic guar solution were prepared from the stock solution. A control body wash with no polymer was also prepared, in which deionized water was substituted for the cationic guar solution. The cationic guar solutions were added while mixing to the body wash stock solution and mixed 15 minutes. Each of these samples was adjusted to pH 8.0-8.5 with 1.0% NaOH solution and mixed an additional 15 minutes.

| Material | Trademark | Supplier | Actives |
|---|---|---|---|
| Hydroxyethylcellulose | Natrosol ® 250HHR-CS | Hercules Inc. | 96.45% |
| Sodium lauryl sulfate | Stepanol ® WAC | Stepan Co. | 29% |
| Sodium laureth sulfate | Rhodapex ® ES-STD | Rhodia | 27% |
| | | | (3-EO) |
| Cocamidopropyl- | Amphosol ® CA | Stepan Co. | 30% |
| betaine | | | active |
| DMDM Hydantoin | Glydant ® | Lonza Group | ’100% |
| Cationic guar | N-Hance ® 3270 | Hercules Inc. | 90.83 |
| Cationic guar | GPX-247 | Hercules Inc. | 90.29% |
| Cationic guar | N-Hance ® 3269 | Hercules Inc. | 90.96% |
| | | | DS |
| Cationic guar | N-Hance ® 3269 | Hercules Inc. | 89.64% |
| Cationic guar | Jaguar ® C-13-S | Rhodia | 90.36% |
| Cationic | Jaguar C ®-162 | Rhodia | 91.08% |
| Hydroxypropyl guar | | | |
| Cationic Guar | Hi-Care ® 1000 | Rhodia | |
| Cationic Guar | Jaguar ® Excel | Rhodia | |

TABLE 3
Bodywash Formulations containing Cationic Polygalactotomannans at pH 5.5-6.5

| Example | Polymer | DS⁵ | Mw⁶ | Concentration | TMA⁷ | Panel 1 | Panel 2 | Panel 3 |
|---|---|---|---|---|---|---|---|---|
| 19 | Control - | — | — | 0 | 0 | None | Trace | Slight |
| | water | | | | | | amine | soapy scent |
| 20 | Jaguar ® | 0.12 | 1,116,000 | 0.4% | 4.3 | None | Slight | Trace |
| | C-13-S¹ | | | | | | Amine | soapy scent |
| 21 | Jaguar ® | 0.14 | 1,115,000 | 0.4% | 0.9 | None | Trace | Trace |
| | C-162² | | | | | | amine | soapy scent |
| 22 | Jaguar ® | | 1,110,000 | 0.4% | 1.45 | None | None | Trace |
| | Excel¹ | | | | (Jul. 1, 2005) | | | soapy scent |
| 23 | N-Hance ® | 0.12 | 1,200,000 | 0.2% | 6.7 | None | Moderate | Moderate |
| | 3196³ | | | | | | (surfactant) | amine |
| 24 | Hi-Care ® | | 723,000 | 0.4% | 4.5 | None | Trace | Slight |
| | 1000¹ | | | | | | amine | soapy scent |
| 25 | N-Hance ® | 0.11 | 546,000 | 0.4% | 12.4 | None | Slight- | Slight |
| | 3270³ | | | | | | moderate | soapy scent |
| | | | | | | | amine | |
| 26 | N-Hance ® | 0.11 | 453,000 | 0.2% | 23.3 | None | Moderate | Moderate |
| | 3269³ | | | | | | (surfactant) | amine |
| 27 | GPX-247⁴ | | 447,000 | 0.4% | 140 | None | Moderate | Trace |
| | | | | | | | Amine | soapy |
| 28 | N-Hance ® | 0.11 | 508,000 | 0.4% | 275 | None | Trace | Slight |
| | 3269³ | | | | | | Amine | Soapy |
| 29 | N-Hance ® | 0.13 | 510,000 | 0.4% | 500 | None | | Trace |
| | 3269³ | | | | | | | soapy |

¹Guar hydroxypropyl trimonium chloride sold under the trademark Jaguar ® by Rhodia.
²Hydroxypropyl guar hydroxypropyltrimonium chloride sold under the trademark Jaguar ® by Rhodia.
³Guar hydroxypropyl trimonium chloride sold under the trademark N-Hance ® by Hercules Incorporated.
⁴Experimental Guar hydroxypropyl trimonium chloride.
⁵The degree of substitution was determined by measurement of the moles of quaternary ammonium groups bound to the polymer backbone using standard NMR techniques of integration.
⁶The weight average molecular weight, Mw, was determined using size exclusion chromatography.
⁷See text.

TABLE 4
Bodywash Formulations containing Cationic Polygalactotomannans at pH 8.0-8.5

| Examples | Polymer | DS⁵ | Mw⁶ | Concentration | TMA⁷ | Panel 1 | Panel 2 | Panel 3 |
|---|---|---|---|---|---|---|---|---|
| 30 | Control - | — | — | 0 | 0 | None | Trace | Moderate |
| | water | | | | | | oxidized odor | soapy scent |
| 31 | Jaguar ® | 0.12 | 1,116,000 | 0.4% | 4.5 | None | Trace oxidized | Trace |
| | C-13-S¹ | | | | | | almost no odor | soapy scent |
| 32 | Jaguar ® | 0.14 | 1,115,000 | 0.4% | 0.9 | None | Trace oxidized | Trace |
| | C-162² | | | | | | odor- less fishy | soapy scent |
| 33 | Jaguar ® | | 1,110,000 | 0.4% | 1.45 | None | Slight | Slight |
| | Excel¹ | | | | | | oxidized odor | soapy scent |
| 34 | Hi-Care ® | | 723,000 | 0.4% | 4.5 | None | Trace oxidized | Slight |
| | 1000¹ | | | | | | almost no odor | soapy scent |
| 35 | N-Hance ® | 0.11 | 546,000 | 0.4% | 12.4 | Trace | Trace oxidized | Slight |
| | 3270³ | | | | | Fishy | odor- less fishy | soapy scent |
| 36 | GPX-247⁴ | | 447,000 | 0.4% | 140 | Slight | Slight | Slight |
| | | | | | | Fishy | Fishy | Fishy |
| 37 | N-Hance ® | 0.11 | 508,000 | 0.4% | 275 | Slight | Slight | Slight |
| | 3269³ | | | | | Fishy | Fishy | Fishy |
| 38 | N-Hance ® | 0.13 | 510,000 | 0.4% | 500 | Trace | Trace oxidized | Slight |
| | 3269³ | | | | | Fishy | odor- less fishy | soapy scent |

¹Guar hydroxypropyl trimonium chloride sold under the trademark Jaguar ® by Rhodia
²Hydroxypropyl guar hydroxypropyltrimonium chloride sold under the trademark Jaguar ® by Rhodia
³Guar hydroxypropyl trimonium chloride sold under the trademark N-Hance ® by Hercules Incorporated
⁴Experimental Guar hydroxypropyl trimonium chloride.
⁵The degree of substation was determined by measurement of the moles of quaternary ammonium groups bound to the polymer backbone using standard NMR techniques of integration.
⁶The weight average molecular weight, Mw, was determined using size exclusion chromatography.
⁷See text.

While the invention has been described with respect to specific embodiments, it should be understood that the invention should not be limited thereto and that many variations and modifications are possible without departing from the spirit and scope of the invention.

What is claimed:

1. A composition comprising a) a functional system selected from the group consisting of personal care product, household care product, and pet care product and b) at least one cationic polygalactotomannan-or cationic derivatized polygalactotomannan in the functional system at a lower limit concentration of 0.005 wt % and an upper limit concentration of 10 wt %, where the cationic polygalactomannan or derivative thereof has a weight average molecular weight (Mw) with a lower limit of 200,000 and an upper limit of 2,000,000, and a trimethylamine content in the cationic polygalactomannan below 25 ppm, wherein the composition, at an alkaline pH, has no discernible amine odor.

2. The composition of claim 1, wherein the at least one cationic polygalactotomannan or cationic derivatized polygalactotomannan is incorporated into the functional system in an amount of less than 1.0 wt %.

3. The composition of claim 1, wherein the at least one cationic polygalactotomannan or cationic derivatized polygalactotomannan is incorporated into the functional system in an amount of less than 0.5 wt %.

4. The composition of claim 1, wherein the upper limit of the cationic polygalactotomannan or cationic derivatized polygalactotomannan is 5.0%.

5. The composition of claim 1, wherein the at least one cationic polygalactotomannan or cationic derivatized polygalactotomannan has a boron content of less than 1000 ppm per gram of polygalactomannan.

6. The composition of claim 1, wherein the at least one cationic polygalactotomannan or cationic derivatized polygalactotomannan has a boron content of less than 500 ppm per gram of polygalactomannan.

7. The composition of claim 1, wherein the at least one cationic polygalactotomannan or cationic derivatized polygalactotomannan has a boron content of less than 50 ppm per gram of polygalactomannan.

8. The composition of claim 1, wherein the at least one cationic polygalactotomannan or cationic derivatized polygalactotomannan has a cationic degree of substitution (DS) lower limit of about 0.01 and an upper limit of about 3.0.

9. The composition of claim 8, wherein the cationic degree of substitution (DS) has a lower limit amount of 0.05.

10. The composition of claim 8, wherein the cationic degree of substitution (ds) has a lower limit amount of 0.1.

11. The composition of claim 8, wherein the cationic degree of substitution (DS) has a lower limit amount of 0.2.

12. The composition of claim 8, wherein the cationic degree of substitution (DS) has an upper limit of about 2.0.

13. The composition of claim 8, wherein the cationic degree of substitution (DS) has an upper limit of about 1.0.

14. The composition of claim 1, wherein the derivative moiety on the cationic derivatized polygalactomannan is selected from the group consisting of alkyl, hydroxyalkyl, alkylhydroxyalkyl, and carboxymethyl wherein the alkyl has a carbon chain containing from 1 to 22 carbons and the hydroxyalkyl is selected from the group consisting of hydroxyethyl, hydroxypropyl, and hydroxybutyl.

15. The composition of claim 1, wherein the polygalactomannan gum is selected from the group consisting of guar, locust bean, honey locus, and flame tree.

16. The composition of claim 1, wherein the cationic moiety on the at least one cationic polygalactotomannan or cationic derivatized polygalactotomannan is selected from quaternary ammonium compounds.

17. The composition of claim 16, wherein the quaternary ammonium compound is selected from the group consisting of 3-chloro-2-hydroxypropyltrimethylammonium chloride, 2,3-epoxy-propyltrimethylammonium chloride, 3-chloro-2-hydroxypropyltrimethylammonium bromide, 2,3-epoxy-propyltrimethylammonium bromide; glycidyltrimethylammonium chloride, glycidyltriethylammonium chloride, gylcidyltripropylammonium chloride, glycidylethyldimethylammonium chloride, glycidyldiethylmethylammonium chloride, and their corresponding bromides and iodides; 3-chloro-2-hydroxypropyltrimethylammonium chloride, 3-chloro-2-hydroxypropyltriethylammonium chloride, 3-chloro-2-hydroxypropyltripropylammonium chloride, 3-chloro-2-hydroxypropylethyldimethylammonium chloride, and their corresponding bromides and iodides; and halides of imidazoline ring containing compounds.

18. The composition of claim 1, wherein the Mw has a lower limit of 350,000.

19. The composition of claim 1, wherein the Mw has a lower limit of 500,000.

20. The composition of claim 1, wherein the Mw has an upper limit of 1,500,000.

21. The composition of claim 1, wherein the Mw has an upper limit of 1,000,000.

22. The composition of claim 1, further comprising a member selected from the group consisting of colorant, preservative, antioxidant, alpha or beta hydroxy acid, activity enhancer, emulsifier, functional polymer, viscosifying agent, alcohol, fat or fatty compound, antimicrobial compound, zinc pyrithione, silicone material, hydrocarbon polymer, emollients, oil, surfactants, suspending agents, biocide and mixtures thereof.

23. The composition of claim 22, wherein the functional polymer is selected from the group consisting of anionic, hydrophobically-modified, and amphoteric acrylic acid copolymers, vinylpyrrolidone homopolymers and copolymers, cationic vinylpyrrolidone copolymers, nonionic, cationic, anionic, and amphoteric cellulosic polymers, acrylamide homopolymers, cationic, anionic, amphoteric, and hydrophobically-modified acrylamide copolymer, polyethylene glycol polymer and copolymer, hydrophobically-modified polyether, hydrophobically-modified polyetheracetal, hydrophobically-modified polyetherurethane, an associative polymer, hydrophobically-modified cellulosic polymer, polyethyleneoxide-propylene oxide copolymer, and a nonionic, anionic, hydrophobically-modified, amphoteric, and cationic polysaccharides, chitosan, and mixtures thereof.

24. The composition of claim 23, wherein the nonionic, cationic, anionic, and amphoteric cellulosic polymers are selected from the group consisting of hydroxyethylcellulose, hydroxypropylcellulose, hydroxypropylmethylcellulose, carboxymethylcellulose, hydrophobically-modified carboxymethylcellulose, cationic hydroxyethylcellulose, cationic hydrophobically-modified hydroxyethyl cellulose, hydrophobically modified hydroxyethylcellulose, hydrophobically-modified hydroxypropylcellulose, cationic hydrophobically-modified hydroxypropyl cellulose, cationic carboxymethylhydroxyethylcellulose, and cationic hydroxypropylcellulose.

25. The composition of claim 23, wherein the nonionic, anionic, hydrophobically modified, amphoteric, and cationic polysaccharides are selected from the group consisting of carboxymethyl guar, alginates, hydroxypropyl guar, hydrophobically-modified guar, carboxymethyl guar hydroxypropyltrimethylammonium chloride, guar hydroxypropyltrimethylammonium chloride, and hydroxypropyl guar hydroxypropyltrimethylammonium chloride.

26. The composition of claim 22, wherein the viscosifying agent is selected from the group consisting of NaCl, NH₄Cl, KCl, Na₂SO₄, fatty alcohols, fatty acid esters, fatty acid amides, fatty alcohol polyethyleneglycol ethers, sorbitol polyethyleneglycol ethers, cocamidopropyl betaine, clays, silicas, cellulosic polymers, guar and guar derivatives, starch and starch derivatives, xanthan, and mixtures thereof.

27. The composition of claim 22, wherein the silicone material is selected from the group consisting of cyclosiloxane, linear siloxane, siloxane structure with polyol, amino, or other functional groups in the siloxane structure, and mixtures thereof.

28. The composition of claim 27, wherein the other functional groups are selected from the group consisting of polyethyleneoxy and/or polypropyleneoxy groups optionally containing C₆-C₂₄ alkyl groups, substituted or unsubstituted amine groups, thiol groups, alkoxylated groups, hydroxyl groups, acyloxyalkyl groups.

29. The composition of claim 22, wherein the silicone material is selected from the group consisting of polyalkylsiloxanes, polyarylsiloxanes, polyalkylarylsiloxanes, and mixtures thereof.

30. The composition of claim 29, wherein the polyalkylsiloxanes are selected from the group consisting of polydimethylsiloxane, polydimethylsiloxane hydroxylated at the end of the chain, and mixtures thereof.

31. The composition of claim 22, wherein the surfactant is anionic, amphoteric, or nonionic.

32. The composition of claim 1, wherein the functional system is a household care or pet care product.

33. The household care or pet care product composition of claim 32, further comprising at least one active household care or pet care ingredient.

34. The household care or pet care product composition of claim 33, wherein the active household ingredient is selected from the group consisting of insect repellent agent, pet deodorizer agent, pet shampoo active, industrial grade bar and liquid soap active, dishwashing soap active, all purpose cleaner, disinfecting agent, rug and upholstery cleaning active, laundry softener active, laundry detergent active, toilet bowl cleaning agent, fabric sizing agent, dust collection agent, antiredeposition agent, textile cleaning agent, and lubricating agent.

35. The household care or pet care product composition of claim 32, wherein the composition also includes at least one additional ingredient selected from the group consisting of colorant, preservative, antioxidant, bleaching agent, activity enhancer, emulsifier, functional polymer, viscosifying agent, alcohol, fat or fatty compound, oil, surfactant, fragrance, suspending agent, silicone material, biocide and mixtures thereof.

36. The composition of claim 1, wherein the functional system is a personal care product.

37. The personal care composition of claim 36, further comprising at least one active personal care ingredient.

38. The personal care composition of claim 37, wherein the active personal care ingredient is selected from the group consisting of perfumes, skin coolants, emollients, deodorants, antiperspirants actives, moisturizing agents, cleansing agents, sunscreen actives, hair treatment agents, oral care agents, denture adhesive agents, shaving actives, beauty aids, and nail care active.

39. The personal care composition of claim 36, wherein the composition is a product selected from the group consisting of hair care, skin care, sun care, nail care, baby care, cosmetics and, oral care.

40. The personal care composition of claim 39, wherein the product is a hair care product comprising a conditioning agent selected from the group consisting of silicone materials, hydrocarbon oils, panthenol and derivatives thereof, pantothenic acid and derivatives thereof, and mixtures thereof.

41. The personal care composition of claim 39, wherein the product is a skin care product comprising a conditioning agent selected from the group of consisting of silicone materials, hydrocarbon oils, panthenol and derivatives thereof, pantothenic acid and derivatives thereof, and mixtures thereof.

42. The personal care composition of claim 36, wherein the composition also includes at least one additional ingredient selected from the group consisting of colorant, preservative, antioxidant, alpha or beta hydroxy acid, activity enhancer, emulsifier, functional polymer, viscosifying agent, alcohol, fat or fatty compound, antimicrobial compound, zinc pyrithione, silicone material, hydrocarbon polymer, emollient, oil, surfactant, flavor, fragrance, medicaments, rejunvenating agents, suspending agents, biocide and mixture thereof.

43. The personal care composition of claim 1, wherein the functional system is an oil-in-water or water-in-oil emulsion or solution or dispersion or suspension.

44. The composition of claim 1, further comprising water in an amount of 50-99% by weight of the total composition.
